(19) United States
(12) Patent Application Publication
(10) Pub. No.: US 2026/0046708 A1
(43) Pub. Date: Feb. 12, 2026

(54) METHOD AND APPARATUS FOR REPORT ON FLIGHT PATH AND MEASUREMENT INFORMATION OF AERIAL UE IN WIRELESS COMMUNICATION SYSTEM

(71) Applicant: Samsung Electronics Co., Ltd., Suwon-si, Gyeonggi-do (KR)

(72) Inventors: Taeseop LEE, Suwon-si (KR); Sangyeob JUNG, Suwon-si (KR)

(21) Appl. No.: 19/150,082

(22) PCT Filed: Jan. 15, 2024
(86) PCT No.: PCT/KR2024/000713

§ 371 Date: Jul. 22, 2025

(30) Foreign Application Priority Data
Jan. 25, 2023 (KR) 10-2023-0009371

(51) Int. Cl. H04W 36/00; H04W 36/30; H04W 36/32

(52) U.S. Cl. CPC H04W 36/0058; H04W 36/30; H04W 36/324

(57) ABSTRACT

The present disclosure relates to a 5G or 6G communication system for supporting a higher data transmission rate than a 4G communication system such as LTE. The present disclosure relates to a method for a report on flight path and measurement information of an aerial UE in a wireless communication system, the method comprising the steps of: transmitting, to a base station, an RRC message including flight path information; on the basis of the RRC message, transmitting, to the base station, UE capability information related to a report function of the flight path information; on the basis of the UE capability information, receiving, from the base station, a report request message of the flight path information; and transmitting, to the base station, a response message to the report request message of the flight path information.

### TECHNICAL FIELD

The disclosure relates to operations of a terminal and a base station in a wireless communication system and, particularly, to a method and a device for reporting flight path and measurement information of an aerial terminal.

### BACKGROUND ART

A review of the development of wireless communication from generation to generation shows that the development has mostly been directed to technologies for services targeting humans, such as voice-based services, multimedia services, and data services. It is expected that connected devices which are exponentially increasing after commercialization of 5th generation (5G) communication systems will be connected to communication networks. Examples of things connected to networks may include vehicles, robots, drones, home appliances, displays, smart sensors installed in various infrastructures, construction machines, factory equipment, and the like. Mobile devices are expected to evolve into various formfactors, such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (i.e., 1,000 giga)-level bps and a radio latency of 100 μsec. That is, 6G communication systems will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mm Wave bands introduced in 5G, a technology capable of securing the signal transmission distance, that is, coverage, will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AI)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Specifically, it is expected that services such as truly immersive XR, high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

### DISCLOSURE OF INVENTION

### Technical Problem

An embodiment of the disclosure provides a method and a device for reporting flight path and measurement information of an aerial terminal in a wireless communication system.

### Solution to Problem

A method performed by a terminal in a wireless communication system according to an embodiment of the disclosure may include: transmitting, to a base station, terminal capability information including information on whether path reporting of the terminal is supported; receiving, from the base station, configuration information regarding the path reporting, based on the terminal capability information; and transmitting path information of the terminal to the base station, based on the configuration information, wherein the path information includes velocity information at at least one location on a path of the terminal, and a threshold time related to a signal strength of a target cell for a handover of the terminal is based on the velocity information.

A method performed by a base station in a wireless communication system according to an embodiment of the disclosure may include: receiving, from a terminal, terminal capability information including information on whether path reporting of the terminal is supported; transmitting, to the terminal, configuration information regarding the path reporting, based on the terminal capability information; and receiving path information of the terminal from the terminal, based on the configuration information, wherein the path information includes velocity information at at least one location on a path of the terminal, and a threshold time related to a signal strength of a target cell for a handover of the terminal is based on the velocity information.

A terminal in a wireless communication system according to an embodiment of the disclosure may include: a transceiver; and at least one controller connected to the transceiver, wherein the at least one controller is configured to: transmit, to a base station, terminal capability information including information on whether path reporting of the terminal is supported; receive, from the base station, configuration information regarding the path reporting, based on the terminal capability information; and transmit path information of the terminal to the base station, based on the configuration information, the path information includes velocity information at at least one location on a path of the terminal, and a threshold time related to a signal strength of a target cell for a handover of the terminal is based on the velocity information.

A base station in a wireless communication system according to an embodiment of the disclosure may include: a transceiver; and at least one controller connected to the transceiver, wherein the at least one controller is configured to: receive, from a terminal, terminal capability information including information on whether path reporting of the terminal is supported; transmit, to the terminal, configuration information regarding the path reporting, based on the terminal capability information; and receive path information of the terminal from the terminal, based on the configuration information, the path information includes velocity information at at least one location on a path of the terminal, and a threshold time related to a signal strength of a target cell for a handover of the terminal is based on the velocity information.

### Advantageous Effects of Invention

The disclosure provides an apparatus and a method capable of effectively providing services in a wireless communication system.

### BRIEF DESCRIPTION OF DRAWINGS

FIG. 1A illustrates a structure of a mobile communication system according to an embodiment of the disclosure.

FIG. 1B illustrates a movement path reporting function of an aerial UE in a mobile communication system according to an embodiment of the disclosure.

FIG. 1C illustrates a newly introduced signaling procedure for implementing an improved flight path reporting function of an aerial UE in a mobile communication system according to an embodiment of the disclosure.

FIG. 1D illustrates a measurement reporting operation function of an aerial UE in a mobile communication system according to an embodiment of the disclosure.

FIG. 1E illustrates a newly introduced signaling procedure for implementing an improved measurement reporting function of an aerial UE in a mobile communication system according to an embodiment of the disclosure.

FIG. 1F is a block diagram illustrating an internal structure of a UE according to an embodiment of the disclosure.

FIG. 1G is a block diagram illustrating a structure of a base station according to an embodiment of the disclosure.

### MODE FOR THE INVENTION

Hereinafter, embodiments of the disclosure will be described with reference to the accompanying drawings. In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

The 5G mobile communication (or wireless communication) system supports the NFs to use the result of collection and analysis of network-related data (hereinafter referred to as network data) through the NWDAF. This is intended to allow each NF to provide the collection and analysis of necessary network data in a centralized form in order to effectively provide its own functions. The NWDAF may collect and analyze network data by using a network slice as a basic unit. However, the scope of the disclosure is not limited to the network slice unit, and the NWDAF may additionally analyze various pieces of information (e.g., quality of service) acquired from a user equipment (UE), a protocol data unit (PDU) session, an NF status, and/or an external service server.

The result analyzed through the NWDAF may be delivered to each NF that has requested the corresponding analysis result, and the delivered analysis result may be used to optimize network management functions such as quality of service (QoS) guarantee/enhancement, traffic control, mobility management, and load distribution.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities (NEs), terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

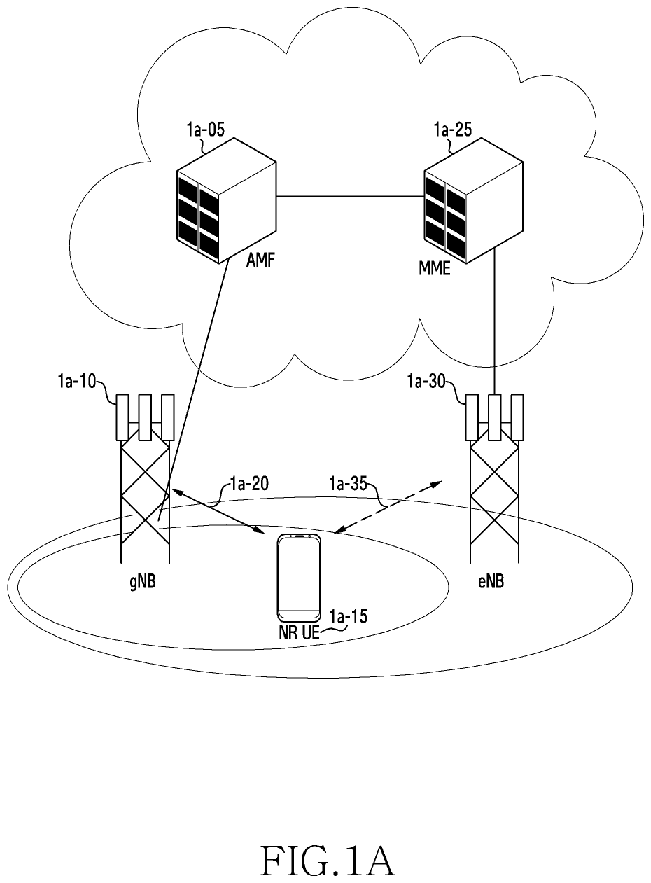

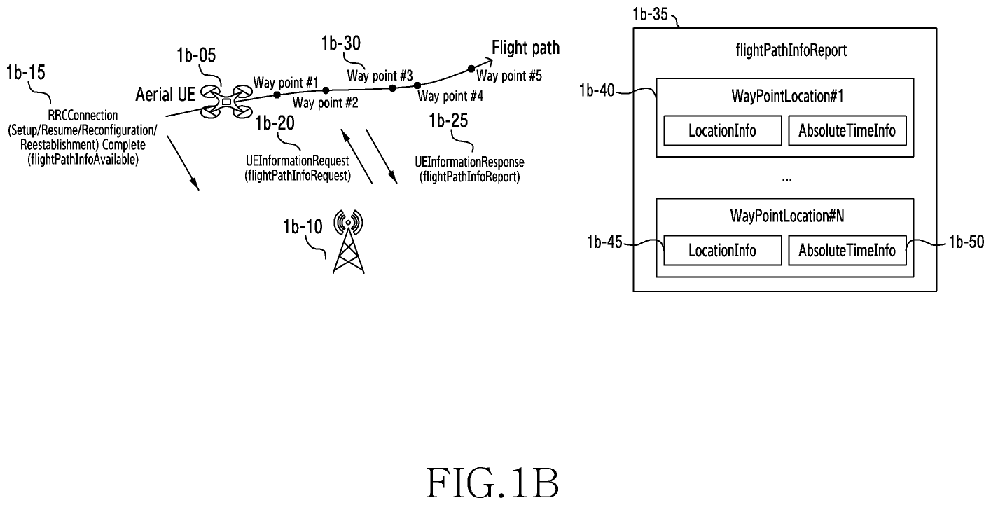

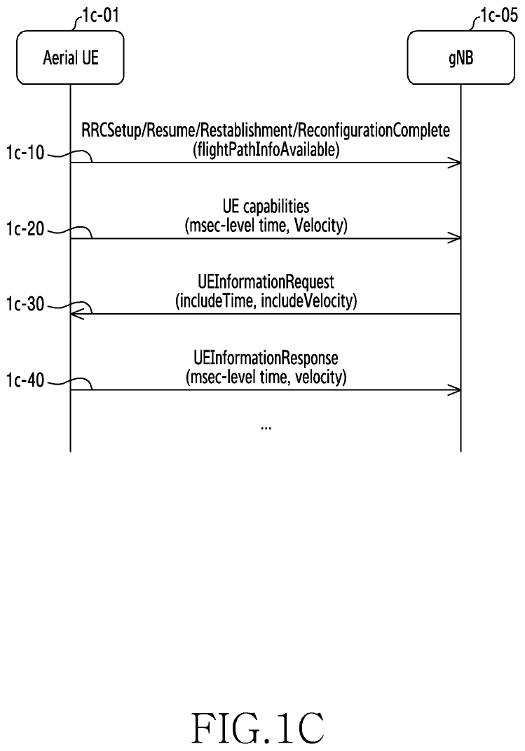

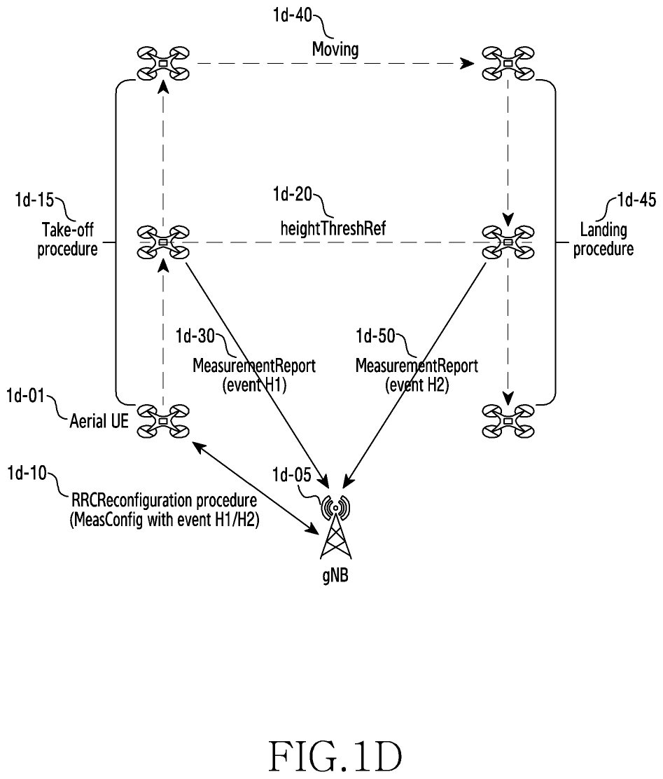

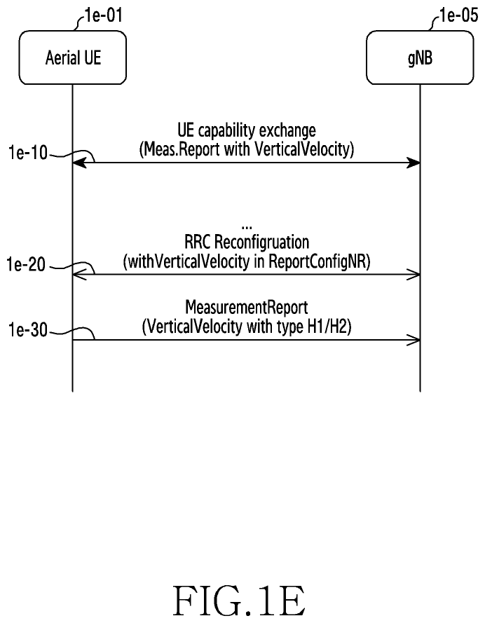

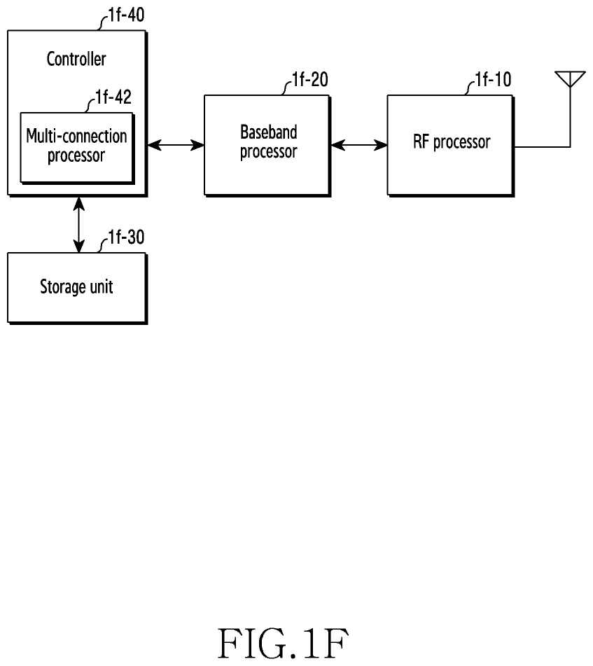

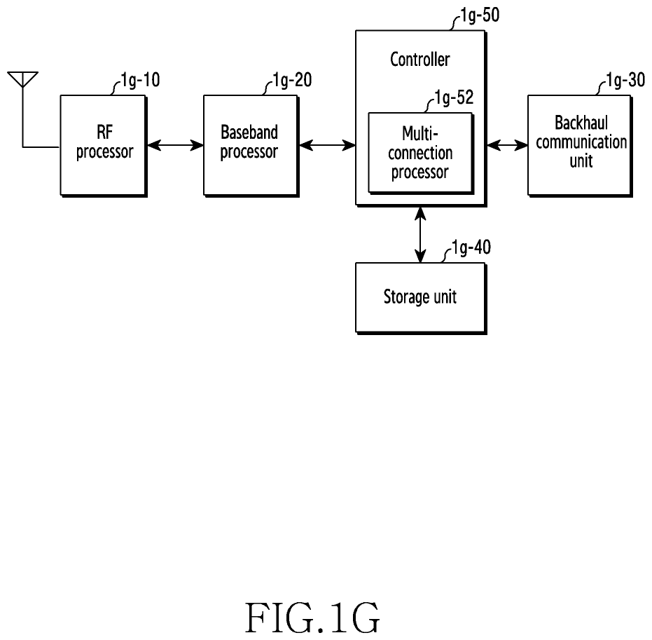

FIG. 1A illustrates a structure of a mobile communication system.

Referring to FIG. 1A, as illustrated therein, a radio access network of a mobile communication (or wireless communication) system (new radio, NR) may include a base station (new radio node B, hereinafter gNB) 1a-10 and an access and mobility management function (AMF) 1a-05. A user terminal (new radio user equipment, hereinafter NR UE, UE, or terminal) 1a-15 may access an external network via the gNB 1a-10 and the AMF 1a-05. In the following, the mobile communication system may refer to an NR communication system or mobile communication (or wireless communication) system beyond the NR communication system.

In FIG. 1A, the gNB may correspond to an evolved node B (eNB) of a conventional LTE system. The gNB may be connected to the NR UE through a radio channel and provide outstanding services as compared to a conventional node B. In the mobile communication system, since all user traffic is serviced through a shared channel, a device that collects state information, such as buffer statuses, available transmit power states, and channel states of UEs, and performs scheduling accordingly may be required, and the gNB 1a-10 may collect buffer statuses, available transmit power states, and channel states of UEs, and perform scheduling accordingly. In general, one gNB may control multiple cells. In order to implement ultrahigh-speed data transfer beyond the existing long term evolution (LTE), the NR communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the NR communication system may employ an adaptive modulation & coding (hereinafter referred to as AMC) scheme for determining a modulation scheme and a channel coding rate according to a channel state of a UE. The AMF 1a-05 may perform functions such as mobility support, bearer configuration, and QoS configuration. The AMF 1a-05 is a device responsible for various control functions as well as a mobility management function for a UE, and may be connected to multiple base stations. In addition, the mobile communication system may interwork with the existing LTE system, and the AMF 1a-05 may be connected to a mobility management entity (MME) 1a-25 via a network interface. The MME 1a-25 may be connected to an eNB 1a-30 that is an existing base station. A UE supporting LTE-NR dual connectivity may transmit/receive data while maintaining connections to both the gNB 1a-10 and the eNB 1a-30 (1a-35).

FIG. 1B is a diagram illustrating a flight path reporting function of an aerial UE in a mobile communication system according to an embodiment of the disclosure.

Referring to FIG. 1B, a mobile communication system may be used as a communication means for aerial vehicles such as an uncrewed/unmanned aerial vehicle (UAV) and an uncrewed/unmanned aerial mobility (UAM). Hereinafter, the communication means for aerial vehicles such as a UAV and a UAM may be referred to as an aerial UE or an aerial terminal. To this end, an aerial UE may be assumed, and a function for supporting a communication service for the aerial UE may be introduced into the mobile communication system.

In the UAV/UAM, there may be a use case in which movement occurs along a predetermined flight path. Therefore, if a base station 1b-10 is aware of the predetermined path, the base station 1b-10 may use information on the predetermined path to support the mobility (e.g., handover) of an aerial UE 1b-05. In order for the base station 1b-10 to use the information on the predetermined path to support the mobility of the aerial UE 1b-05, the aerial UE 1b-05 may notify the base station 1b-10 that the aerial UE 1b-05 has flight path information, by using a predetermined radio resource control (RRC) message (e.g., including at least one of RRCConnectionSetupComplete, RRCConnectionResumeComplete, RRCConnectionReestablishmentComplete, or RRCConnectionReconfigurationComplete) (1b-15). The base station 1b-10 may request the flight path information from the aerial UE 1b-05 through a UEInformationRequest message 1b-20, and the aerial UE 1b-5 having received the request may report the flight path information (e.g., information element (IE) FlightPathInfoReport)) through a UEInformationResponse message 1b-25. Flight path information 1b-35 may be configured in the form of a list of information 1b-40 on each waypoint (location point) through which the aerial UE 1b-05 is required to pass. In this case, the information 1b-40 on each waypoint may be configured by location information 1b-45 of each waypoint and expected time information 1b-50 at the time of passing a corresponding waypoint. In this case, the expected time information 1b-50 at the waypoint may be reported in units of seconds (sec-level).

When the base station 1b-10 requests the flight path information from the aerial UE 1b-05 through the UEInformationRequest message 1b-20, the base station 1b-10 may indicate the maximum number of waypoints (or the number of waypoints to be reported) that can be reported through the UEInformationResponse message 1b-25 by the aerial UE 1b-05 and whether to include the time information 1b-50 in the information 1b-40 on each waypoint.

The aerial UE 1b-05 may report the flight path information to the base station 1b-10 through the UEInformationResponse message 1b-25. The aerial UE 1b-05 may arbitrarily report information on N waypoints to the base station 1b-10 within the maximum number of waypoints configured by the base station 1b-10 through the UEInformationRequest message 1b-20 or the maximum number of waypoints defined in the specification. Alternatively, when the base station 1b-10 configures the number of waypoints to be reported, the aerial UE 1b-05 may report, to the base station 1b-10, information on the waypoints, the number of which is configured by the base station 1b-10. In addition, the aerial UE 1b-05 may include the time information 1b-50 only when the base station 1b-10 indicates the aerial UE to include the time information in the waypoint information 1b-40 through the UEInformationRequest message 1b-20, or may include the time information even without such a configuration from the base station 1b-10.

FIG. 1C is a diagram illustrating a newly introduced signaling procedure for implementing an improved flight path reporting function of an aerial UE in a mobile communication system according to an embodiment of the disclosure.

Referring to FIG. 1C, flight path information reported by an aerial UE 1c-01 to a base station 1c-05 as shown in FIG. 1B may be used by the base station 1c-05 to support the mobility of the aerial UE 1c-01. For example, the base station 1c-05 may optimize time and configuration information for handing over the aerial UE 1c-01 to another neighboring base station, based on expected flight path information of the UE. In relation to mobility support, 1) an exact time point at which the UE reaches a specific waypoint and 2) velocity information at a time point at which the aerial UE passes a specific waypoint may be effectively used. For example, the base station 1c-05 may configure the aerial UE 1c-01 to perform a handover through a conditional handover configuration when a time during which a specific condition (e.g., a signal of a handover target cell being greater than or equal to a certain level) is satisfied becomes greater than or equal to a specific time threshold value (e.g., timeToTrigger). In this case, if information on the exact time point and velocity at which the aerial UE 1c-01 passes a specific waypoint is provided, the base station 1c-05 may optimize a time threshold value (e.g., timeToTrigger) configuration, etc., based on the information on the exact time point and velocity at which the aerial UE 1c-01 passes a specific waypoint. Therefore, in an embodiment of the disclosure, a procedure may be proposed for enabling the UE to include, for each waypoint, exact time information (e.g., time information in units of msec) and velocity information at the time at which the aerial UE passes a corresponding waypoint when the UE reports flight path information. A specific procedure may be described as follows.

In step 1c-10, the aerial UE 1c-01 may notify the base station 1c-05 that the aerial UE 1c-01 has flight path information, by using a predetermined RRC message (e.g., including at least one of RRCConnectionSetupComplete, RRCConnectionResumeComplete, RRCConnectionReestablishmentComplete, or RRCConnectionReconfigurationComplete).

In step 1c-20, the aerial UE 1c-01 and the base station 1c-05 may exchange UE capability information. In this case, the aerial UE 1c-01 may report UE capability information (e.g., UE capability information) related to a flight path information reporting function to the base station 1c-05. Specifically, the aerial UE 1c-01 may report to the base station 1c-05 whether the aerial UE may report a time point at which the aerial UE passes each waypoint in units of seconds (sec) or units of msec when reporting a flight path. In addition, the aerial UE 1c-01 may report to the base station 1c-05 whether the aerial UE may report a velocity at a time point at which the aerial UE passes each waypoint when reporting a flight path. For the above-described reporting, a UE capability information variable for indicating whether the aerial UE 1c-01 may report time information in units of seconds (msec) or units of msec at a time point at which the aerial UE passes a waypoint when reporting a flight path, and a new variable of UE capability information for indicating whether the aerial UE may report velocity information at a time point at which the aerial UE passes a waypoint may be defined.

In step 1c-30, the base station 1c-05 may configure the aerial UE 1c-01 to report a flight path through a predetermined RRC message (e.g., UEInformationRequest message). In this case, the base station 1c-05 may indicate whether the aerial UE 1c-01 is to report time information (in other words, a time point at which the aerial UE passes each waypoint) of each waypoint constituting the flight path in units of seconds as before or in units of msec as an enhanced method. Therefore, an indicator (e.g., includeTimeStamp-rxx) for indicating whether to include time information of a waypoint in a report of a flight path reported by the aerial UE 1c-01, and indicating a time unit (e.g., units of seconds or units of msec) by which the reporting is to be performed may be defined in the form of ENUMERATE within a FlightPathInfoReportConfig IE included in a UEInformationRequest message 1c-30 as shown in Table 1 below.

TABLE 1

| FlightPathInfoReportConfig-rxx ::= SEQUENCE { | |
|---|---|
| maxWayPointNumber-rxx | INTEGER (1..maxWayPoint-r15), |
| includeTimeStamp-rxx | ENUMERATED {sec, msec} OPTIONAL |

}

The base station 1c-05 may use the above-described indicator to indicate time information reporting only when the aerial UE 1c-01 has reported in step 1c-20 that the aerial UE may provide time information on a time point at which the aerial UE passes each waypoint when reporting the flight path. If the aerial UE 1c-01 has reported in step 1c-20 that the aerial UE can support only a part of either the units of seconds (sec) or the units of msec, the base station 1c-05 may indicate the aerial UE 1c-01 to report the time information in the unit supported by the aerial UE 1c-01. Additionally, the base station 1c-05 may simply indicate the aerial UE to report the time information together with the flight path, and also indicate the aerial UE 1c-01 to arbitrarily select and report one of time units supportable by the aerial UE 1c-01. In this case, an indicator for indicating time information reporting may be defined as shown in Table 2 below.

TABLE 2
FlightPathInfoReportConfig-rxx ::= SEQUENCE {

| | |
|---|---|
| maxWayPointNumber-rxx | INTEGER (1..maxWayPoint-r15), |
| includeTimeStamp-rxx | ENUMERATED {True} OPTIONAL |

}

In addition, when the aerial UE 1c-01 reports the flight path, the base station 1c-05 may also indicate whether to include velocity information (e.g., velocity information at a time point at which the aerial UE passes each waypoint) of each waypoint. Therefore, an indicator (e.g., include Velocity-rxx) for indicating whether to include velocity information at a time point at which the aerial UE passes a waypoint when the aerial UE 1c-01 reports the flight path may be defined in the form of ENUMERATE as shown in Table 3 below.

TABLE 3
FlightPathInfoReportConfig-rxx ::= SEQUENCE {

| maxWayPointNumber-rxx | INTEGER (1..maxWayPoint-r15), | |
|---|---|---|
| includeTimeStamp-rxx | ENUMERATED {sec, msec} | OPTIONAL, |
| includeVelocity-rxx | ENUMERATED {True} | OPTIONAL |

}

In addition, there may be various formats representing the velocity information of the aerial UE 1c-01. For example, depending on whether horizontal velocity, vertical velocity, velocity uncertainty, etc. are included, various velocity information representation formats (e.g., at least one of horizontalVelocity, horizontalWithVerticalVelocity, horizontalVelocityWithUncertainty, or horizontalWithVerticalVelocityandUncertainty) may be used to represent the velocity information of the aerial UE 1c-01. Therefore, when the base station 1c-05 indicates the aerial UE 1c-01 to include the velocity information while indicating path reporting, the base station may specifically indicate which of the above-described various formats is to be used. For example, when the base station 1c-05 requires all of horizontal velocity, vertical velocity, and velocity uncertainty information in order to optimize the mobility support of the aerial UE 1c-01, the base station may indicate the aerial UE 1c-01 to report the velocity information in a horizontalWithVerticalVelocityandUncertainty format when reporting the flight path. On the other hand, when the base station 1c-05 determines that only horizontal velocity is required to optimize the mobility support of the aerial UE 1c-01, the base station may indicate the aerial UE 1c-01 to report the velocity information in a horizontal Velocity format when reporting the flight path, thereby reducing unnecessary signaling load. Therefore, an indicator (e.g., include Velocity-rxx) for indicating whether to include velocity information at a time point at which the aerial UE passes a waypoint when the aerial UE 1c-01 reports the flight path may be defined in the form as shown in Tables 4 and 5 below.

TABLE 4
FlightPathInfoReportConfig-rxx ::= SEQUENCE {

| maxWayPointNumber-rxx | INTEGER (1..maxWayPoint-r15), | |
|---|---|---|
| includeTimeStamp-rxx | ENUMERATED {sec, msec} | OPTIONAL, |
| includeVelocity-rxx | VelocityTypes | OPTIONAL |

}
VelocityTypes ::= CHOICE {

| | |
|---|---|
| horizontalVelocity | BOOLEAN, |
| horizontalWithVerticalVelocity | BOOLEAN, |
| horizontalVelocityWithUncertainty | BOOLEAN, |
| horizontalWithVerticalVelocityAndUncertainty | BOOLEAN, |

...
}

TABLE 5
FlightPathInfoReportConfig-rxx ::= SEQUENCE {

| maxWayPointNumber-rxx | INTEGER (1..maxWayPoint-r15), | |
|---|---|---|
| includeTimeStamp-rxx | ENUMERATED {sec, msec} | OPTIONAL, |

| | |
|---|---|
| includeVelocity-rxx | ENUMERATED { horizontalVelocity, |

horizontalWithVerticalVelocity, horizontalVelocityWithUncertainty,

| | |
|---|---|
| horizontalWithVerticalVelocityAndUncertainty} | OPTIONAL |

}

In addition, considering various formats of velocity information, in step 1c-20, the aerial UE 1c-01 may report a supportable velocity format while reporting velocity information reporting capability.

In step 1c-40, the aerial UE 1c-01 may report the flight path through a predetermined RRC message (e.g., a UEInformationResponse message) according to a configuration of the base station 1c-05 in step 1c-30. The aerial UE 1c-01 may arbitrarily report information on N waypoints to the base station 1c-05 within the maximum number of waypoints configured by the base station 1c-05 through the UEInformationRequest message 1c-30 or the maximum number of waypoints defined in the specification. Alternatively, when the base station 1c-05 configures the number of waypoints to be reported, the aerial UE 1c-01 may report information on the configured number of waypoints to the base station 1c-05. Therefore, the aerial UE 1c-01 may include flight path information (e.g., a list consisting of waypoints) in the UEInformationResponse message in the manner as shown in the example below. In this case, a CommonLocationInfo-r16 IE, which is already defined in the NR RRC specification (e.g., TS 38.331), may be used as location information of each waypoint as shown in Table 6 below.

TABLE 6

| | |
|---|---|
| FlightPathInfoReport-rxx ::= | SEQUENCE { |

flightPath-rxx SEQUENCE (SIZE (0..maxWayPoint-r15)) OF WayPointLocation-rxx OPTIONAL
}

| | |
|---|---|
| WayPointLocation-rxx ::= | SEQUENCE { |
| wayPointLocation-rxx | CommonLocationInfo-r16; |

}

When, in step 1c-30, the base station 1c-05 indicates the aerial UE to include time information on when the aerial UE passes each waypoint in the flight path report of the aerial UE 1c-01, the aerial UE 1c-01 may include and report the time information for each waypoint. Alternatively, even when the base station 1c-05 does not explicitly indicate the aerial UE to include the time information in step 1c-30, the aerial UE 1c-01 may include and report the time information according to a manner defined in the specification. In order to report the time information for each waypoint, one of the following options or a combination of the options may be used.

Option 1. A method for reusing a locationTimestamp-r16 field in a CommonLocationInfo-r16 IE already defined in the NR RRC specification (e.g. TS 38.331): The aerial UE 1c-01 may include a locationTimestamp field defined in a CommonLocationInfo IE for each waypoint when reporting a flight path. In this case, the location Timestamp field may indicate a UTC-Time-r15 IE already defined in the NR LPP specification (e.g., TS 37.355).

TABLE 7

| CommonLocationInfo-r16 ::= SEQUENCE { | |
|---|---|
| <<Ommited>> | |
| locationTimestamp-r16 | OCTET STRING OPTIONAL, |
| <<Ommited>> | |
| } | |
| UTC-Time-r15 ::= SEQUENCE { | |
| utcTime-r15 | UTCTime, |
| utcTime-ms-r15 | INTEGER (0..999), |

...
}

In Table 7, the UTC-Time-r15 IE may be defined to include UTC Time information in units of msec. Therefore, when, in step 1c-30, the base station 1c-05 indicates the aerial UE 1c-01 to include time information in units of msec when reporting the flight path, the aerial UE 1c-01 may report the time information by using the predefined UTC-Time-r15 IE according to the manner of Option 1. However, when, in step 1c-30, 1) the base station 1c-05 has indicated the aerial UE 1c-01 to include time information in units of seconds (sec) when reporting the flight path or 2) the base station 1c-05 has indicated the aerial UE to include time information in units of msec but the aerial UE 1c-01 does not support reporting the time information in units of msec, the base station 1c-05 may have difficulty using the predefined UTC-Time-r15 IE. In the case of the predefined UTC-Time-r15 IE, since a field (utcTime-ms-r15) indicating the time information in units of msec is defined to be mandatorily included, even when the time information in units of sec is required to be reported due to the configuration of the base station 1c-05 or limitations of the aerial UE 1c-01 as described above, the aerial UE 1c-01 may be required to include predetermined information in a corresponding field (e.g., utcTime-ms-r15). In this case, the base station 1c-05 may mistakenly regard meaningless time information in units of msec (e.g., utcTime-ms-r15), which is reported by the aerial UE 1c-01 by entering a predetermined value, as meaningful information, and may fail to optimize the mobility support of the aerial UE 1c-01. In order to alleviate the above-described problem situation, when the aerial UE 1c-01 1) is configured to report the time information in units of sec in step 1c-30 or 2) does not support the time information in units of msec, the specification may specify that a utcTime-ms-r15 field be filled with a value of “0” or NULL when reported. However, when the base station 1c-05 processes the utcTime-ms-r15 field value including “0” or NULL, ambiguity may still exist since the base station cannot accurately distinguish whether a corresponding time information msec unit value is actually “0” or the UE has reported a value of “0” not to include msec information. However, the above-described ambiguity may be resolved by the information exchanged between the aerial UE 1c-01 and the base station 1c-05 in steps 1c-10 and 1c-20. Specifically, assuming that, in step 1c-20, the base station 1c-05 indicates the aerial UE 1c-01 to include the time information in units of sec when reporting the flight path, the base station 1c-05 has initially indicated the aerial UE 1c-01 to report the time information in units of sec, and thus the base station 1c-05 may ignore a field (e.g., utcTime-ms-r15) indicating the time information in units of msec in flight path information reported by the aerial UE 1c-01. In addition, when only the time information in units of sec can be reported due to limitations of the aerial UE 1c-01, ambiguity may be resolved through the UE capability information parameter described above in step 1c-20. If, as described above in step 1c-20, the aerial UE 1c-01 has reported to the base station 1c-05 that the aerial UE cannot include the time information in units of msec when reporting the flight path through a capability information parameter, the base station 1c-05 may ignore the field (e.g., utcTime-ms-r15) indicating the time information in units of msec in the flight path information reported by the aerial UE 1c-01.

Option 2. A method for defining a new time information IE which may optionally include time information in units of msec.

Option 2-1. In order to eliminate ambiguity arising from reusing a UTC-Time-r15 IE, which essentially includes time information in units of msec, as described in Option 1, a new UTC-Time-rxx IE may be defined as shown in Table 8 below, and a location Timestamp field defined in a CommonLocationInfo IE may be configured (or defined) to indicate the corresponding IE.

TABLE 8
CommonLocationInfo-r16 ::= SEQUENCE {
<<Omitted>>

| | | |
|---|---|---|
| locationTimestamp-r16 | OCTET STRING | OPTIONAL, |

<<Omitted>>
}
UTC-Time-rXX ::= SEQUENCE {

| utcTime-rxx | UTCTime, | |
|---|---|---|
| utcTime-ms-rxx | INTEGER (0..999) | OPTIONAL, |

...
}

In this case, since a field (e.g., utcTime-ms-rxx) indicating time information in units of msec in a newly defined UTC-Time IE is an optional (optionally configurable) field, the aerial UE 1c-01 may include the corresponding field only when meaningful time information in units of msec exists when reporting a flight path, so as to resolve ambiguity which arises when Option 1 is used. The aerial UE 1c-01 may configure and report time information in flight path information in units of seconds (sec) or units of msec according to the configuration of the base station 1c-05 in step 1c-20.

Option 2-2. In order to eliminate ambiguity arising from reusing a UTC-Time-r15 IE, which essentially includes time information in units of msec, as described in Option 1, a new UTC-Time-rxx IE may be defined as shown in Table 9 below, and a timeStamp field in a WayPointLocation IE may be defined to indicate the corresponding IE.

TABLE 9

| | |
|---|---|
| FlightFathInfoReport-rxx ::= | SEQUENCE { |

flightPath-rxx SEQUENCE (SIZE (0..maxWayPoint-r15)) OF WayPointLocation-rxx OPTIONAL
}

| | |
|---|---|
| WayPointLocation-rxx ::= | SEQUENCE { |

| | |
|---|---|
| wayPointLocation-rxx | CommonLocationInfo-r16, |
| timeStamp-rxx | UTC-Time-rxx OPTIONAL |

}
UTC-Time-rXX ::= SEQUENCE {

| utcTime-rxx | UTCTime, | |
|---|---|---|
| utcTime-ms-rxx | INTEGER (0..999) | OPTIONAL, |

...
}

In this case, since a field (e.g., utcTime-ms-rxx) indicating time information in units of msec in a newly defined UTC-Time IE, as in Option 2-1, is an optional (optionally configurable) field, the aerial UE 1c-01 may include the corresponding field only when meaningful time information in units of msec exists when reporting a flight path, so as to resolve ambiguity which arises when Option 1 is used. The aerial UE 1c-01 may configure and report time information in flight path information in units of seconds (sec) or units of msec according to the configuration of the base station 1c-05 in step 1c-20.

In addition, when, in step 1c-30, the base station 1c-05 indicates the aerial UE 1c-01 to include velocity information at a time point at which the aerial UE passes each waypoint when reporting the flight path, the aerial UE 1c-01 may include the velocity information according to the configuration of the base station 1c-05. In addition, even when the base station 1c-05 does not explicitly indicate the aerial UE to include the velocity information in step 1c-30, the aerial UE 1c-01 may include the time information according to a manner defined in the specification. In order to report velocity information for each waypoint, a velocityEstimate-r16 field in a CommonLocationInfo-r16 IE predefined in the NR RRC specification (e.g., TS 38.331) may be reused as shown in Table 10 below.

TABLE 10
CommonLocationInfo-r16 ::= SEQUENCE {
<<omitted>>

| | |
|---|---|
| velocityEstimate-r16 OCTET STRING | OPTIONAL |

}
Velocity ::= CHOICE {

| | |
|---|---|
| horizontalVelocity | HorizontalVelocity, |
| horizontalWithVerticalVelocity | HorizontalWithVerticalVelocity, |
| horizontalVelocityWithUncertainty | HorizontalVelocityWithUncertainty, |

horizontalWithVerticalVelocityAndUncertainty

HorizontalWithVerticalVelocityAndUncertainty,

...
}

In this case, the aerial UE 1c-01 may include CommonLocationInfo-r16 as location information of each waypoint while reporting the flight path, and may use the velocityEstimate-r16 field in the CommonLocationInfo-r16 in order to add velocity information. In addition, when the base station 1c-05 indicates the aerial UE to report velocity information in a specific format in step 1c-30, the aerial UE 1c-01 may report the velocity information in the specific format according to the configuration of the base station 1c-05. In step 1c-30, when the base station 1c-05 indicates the aerial UE to report the velocity information without an indication for a specific format, the aerial UE 1c-01 may report the velocity information by using a predetermined velocity format when reporting the flight path.

FIG. 1D is a diagram illustrating a measurement reporting operation function of an aerial UE in a mobile communication system according to an embodiment of the disclosure.

Referring to FIG. 1D, a base station 1d-05 may configure an aerial UE 1d-01 to report a corresponding event to the base station 1d-05 through MeasurementReport messages 1d-30 and 1d-50 when an event (hereinafter, event H1) in which the altitude of the aerial UE 1d-01 increases to greater than or equal to a specific threshold value 1d-20 or an event (hereinafter, event H2) in which the altitude decreases to less than or equal to the threshold value has occurred, through an RRCReconfiguration procedure 1d-10 with the aerial UE 1d-01. The base station 1d-05 may identify a takeoff 1d-15 or landing 1d-45 state of the aerial UE 1d-01, based on the event H1 or event H2 reported by the aerial UE 1d-01, and may modify a connection configuration according to a flight state. For example, when the aerial UE 1d-01 takes off and communicates with the base station 1d-05 at a high altitude, a signal transmitted by the aerial UE 1d-01 may affect not just the serving base station 1d-05 but also a neighboring base station as an interference signal. Therefore, when the event H1, in which the altitude of the aerial UE 1d-01 increases to greater than or equal to a certain level, is reported, the base station 1d-05 may adjust a transmission power of the aerial UE 1d-01 to mitigate the interference at the neighboring base station. The aerial UE 1d-01 may be configured to report the event H1 or the event H2 depending on the altitude, and a specific procedure by which the aerial UE 1d-01 reports a corresponding event upon its occurrence, according to a configuration, may be described as follows.

In step 1d-10, the base station 1d-05 may indicate the aerial UE 1d-01 to perform a signal measurement and report a measurement result, through the RRCReconfiguration procedure with the aerial UE 1d-01. In this case, when the event H1 in which the altitude of the aerial UE 1d-01 increases to greater than or equal to the threshold value 1d-20 and the event H2 in which the altitude decreases to less than or equal to the threshold value 1d-20 have occurred, the aerial UE 1d-01 may be configured to report the corresponding event. In this embodiment, for ease of explanation, it is assumed that an altitude threshold value configured for the event H1 and an altitude threshold value configured for the event H2 are configured to a common single value, but, in practice, separate threshold values may be configured for each of the two events. In addition, the base station 1d-05 may indicate the aerial UE 1d-01 to include location information (LocationInformation) of the aerial UE 1d-01 in addition to signal measurement information for a serving cell and neighboring cells while reporting the event H1 or H2.

In step 1d-15, when the aerial UE 1d-01 takes off to start flight 1d-40 and the altitude of the aerial UE 1d-01 increases to greater than or equal to the predetermined threshold value 1d-20, the event H1 configured by the base station 1d-05 may occur in step 1d-10. In this case, the aerial UE 1d-01 may report to the base station 1d-05 that an event has occurred through a MeasurementReport message 1d-30. In this case, the MeasurementReport message 1d-30 may include the signal measurement information for the serving cell and the neighboring cells. In addition, when, in step 1d-10, the base station 1d-05 indicates the aerial UE 1d-01 to include location information in the MeasurementReport message 1d-30 when the event H1 occurs, the location information of the aerial UE 1d-01 may also be included in the MeasurementReport message 1d-30.

In step 1d-45, when the aerial UE 1d-01 completes the flight 1d-40 and lands, and the altitude of the aerial UE 1d-01 decreases to less than or equal to the predetermined threshold value 1d-20, the event H2 configured by the base station 1d-05 may occur in step 1d-10. In this case, the aerial UE 1d-01 may report to the base station 1d-05 that an event has occurred through the MeasurementReport message 1d-50. In this case, the MeasurementReport message 1d-50 may include the signal measurement information for the serving cell and the neighboring cells. In addition, when, in step 1d-10, the base station 1d-05 indicates the aerial UE 1d-01 to include location information in the MeasurementReport message 1d-50 when the event H2 occurs, the location information of the aerial UE 1d-01 may also be included in the MeasurementReport message 1d-50.

FIG. 1E is a diagram illustrating a newly introduced signaling procedure for implementing an improved measurement reporting function of an aerial UE in a mobile communication system according to an embodiment of the disclosure.

Referring to FIG. 1E, when events H1 and H2 occur, as in FIG. 1D, information reported by an aerial UE 1e-01 to a base station 1e-05 through a MeasurementReport message may help the base station 1e-05 identify a takeoff and landing state of the corresponding aerial UE 1e-01 and perform subsequent necessary operations. For example, when the aerial UE 1e-01 has reported the event H1, the base station 1e-05 may identify that the corresponding aerial UE 1e-01 has started flight, and may obtain flight path information of the aerial UE 1e-01 as in the embodiment of FIG. 1C described above. In addition, when the aerial UE 1e-01 has reported the event H1, the base station 1e-05 may perform a procedure for controlling a transmission power of the aerial UE 1e-01 to control signal interference to neighboring cells when the aerial UE 1e-01 has transmitted a signal at a high altitude. In relation to a configuration operation of the base station 1e-05 according to the altitude of the aerial UE 1e-01, vertical velocity information regarding how quickly the aerial UE 1e-01 is ascending or descending in altitude may be useful. For example, when the aerial UE 1e-01 includes velocity information indicating that the aerial UE 1e-01 is rapidly vertically ascending while increasing its altitude and reporting the event H1, the base station 1e-05 may optimize an interference control operation by advancing a start time point of a transmission power control for the aerial UE 1e-01 and shortening a period of a transmission power control command message. Therefore, in an embodiment of the disclosure, when the aerial UE 1e-01 performs a measurement operation according to a configuration of the base station 1e-05 and reports a measurement result, a procedure for including velocity information (e.g., velocity information including vertical velocity information) may be proposed. A specific procedure may be described as follows.

In step 1e-10, the aerial UE 1e-01 and the base station 1e-05 may exchange UE capability information. In this case, the aerial UE 1e-01 may report capability information related to measurement and measurement reporting functions to the base station 1e-05. Specifically, the aerial UE 1e-01 may report to the base station 1e-05 whether velocity information (e.g., velocity information including vertical velocity information) at a reporting time point may be reported together when reporting a measurement result (e.g., Meas.Report with VerticalVelocity). Therefore, a UE capability information variable for indicating whether the aerial UE 1e-01 may include velocity information (e.g., velocity information including vertical velocity information) in a measurement report message (e.g., a MeasurementReport message) may be newly defined.

In step 1e-20, the base station 1e-05 may configure (or indicate) the aerial UE 1e-01 to perform a measurement according to the configuration of the base station 1e-05 and report a measurement result through an RRCReconfiguration procedure. In this case, the aerial UE 1e-01 may be configured to report a corresponding event when the event H1 in which the altitude of the aerial UE 1e-01 increases to greater than or equal to a specific threshold value and the event H2 in which the altitude decreases to less than or equal to the threshold value have occurred. In addition, the base station 1e-05 may configure (or indicate) the aerial UE 1e-01 to report velocity information (e.g., velocity information including vertical velocity information) at a reporting time point together when reporting the event H1 or H2 through a MeasurementReport message 1e-30 below. For the above-described configuration, a new indicator (e.g., include VerticalVelocity-rxx) may be defined in an EventTriggerConfig IE included in an RRCReconfiguration message as shown in Table 11 below.

TABLE 11

| | |
|---|---|
| EventTriggerConfig::= | SEQUENCE { |

<<omitted>>

| | | |
|---|---|---|
| includeCommonLocationInfo-r16 | ENUMERATED {true} | OPTIONAL, -- Need R |
| includeVerticalVelocity-rxx | ENUMERATED {true} | OPTIONAL, -- Need R |

<<omitted>>
}

When the base station 1e-05 configures a new indicator (e.g., include VerticalVelocity-rxx) to “True”, the aerial UE 1e-01 may include velocity information (e.g., velocity information including vertical velocity information) while reporting a measurement result through the MeasurementReport message when a measurement event configured through a corresponding EventTriggerConfig IE occurs.

In addition, when the aerial UE 1e-01 uses an Option 1 scheme (e.g., a scheme of using a velocityEstimate-r16 field in CommonLocationInfo-r16 included in a MeasurementReport message) to include and report velocity information in step 1e-30 below, the base station 1e-05 may configure a value of an indicator (e.g., include VerticalVelocity-rxx) for indicating the aerial UE to include velocity information to “True” only when a value of an indicator (e.g., includeCommonLocationInfo-r16) for indicating the aerial UE to include a CommonLocationInfo IE is configured to “True”. In this case, a conditional code may be added as shown in Table 12 below to specify a condition under which an include VerticalVelocity-rxx value is configured in the specification.

TABLE 12

| | |
|---|---|
| EventTriggerConfig ::= | SEQUENCE { |

<<omitted>>

| | | |
|---|---|---|
| includeCommonLocationInfo-r16 | ENUMERATED {true} | OPTIONAL, -- Need R |
| includeVerticalVelocity-rxx | ENUMERATED {true} | OPTIONAL, -- Cond CommonLocation |

<<omitted>>
}

A conditional code (e.g., CommonLocation) may mean that an include VerticalVelocity-rxx indicator may be configured (or included) when an includeCommonLocationInfo-r16 indicator is configured to “True”, and may mean that the include VerticalVelocity-rxx indicator may not be configured (or included) otherwise.

In addition, the base station 1e-05 may specifically indicate a velocity format (e.g., including at least one of horizontalVelocity, horizontalWith VerticalVelocity, horizontalVelocityWithUncertainty, or horizontalWith VerticalVelocityAndUncertainty) to be used when the aerial UE 1e-01 includes velocity information in step 1e-30 below. Therefore, a new indicator (e.g., include Velocity-rxx) may be defined in the EventTriggerConfig IE included in the RRCReconfiguration message in the form shown in Table 13 or Table 14 below.

TABLE 13

| | |
|---|---|
| EventTriggerConfig::= | SEQUENCE { |

<<omitted>>

| | | |
|---|---|---|
| includeCommonLocationInfo-x16 | ENUMERATED {true} | OPTIONAL, -- Need R |

| | |
|---|---|
| includeVelocity-rxx VelocityTypes | OPTIONAL, -- Need R |

<<omitted>>
}
VelocityTypes ::= CHOICE {

| | |
|---|---|
| horizontalVelocity | BOOLEAN, |
| horizontalWithVerticalVelocity | BOOLEAN, |
| horizontalVelocityWithUncertainty | BOOLEAN, |
| horizontalWithVerticalVelocityAndUncertainty | BOOLEAN, |

...
}

TABLE 14

| | |
|---|---|
| EventTriggerConfig::= | SEQUENCE { |

<<omitted>>

| | |
|---|---|
| includeCommonLocationInfo-r16 | ENUMERATED {true} OPTIONAL, -- Need R |

```
  includeVelocity-rxx ENUMERATED {horizontalVelocity, horizontalWithVerticalVelocity,
horizontalVelocityWithUncertainty, horizontalWithVerticalVelocityAndUncertainty} OPTIONAL,-- Need R
    ...
}
```

The base station 1e-05 may indicate the aerial UE to include and report location information (e.g., LocationInformation) of the aerial UE 1e-01 in addition to signal measurement information for a serving cell and neighboring cells.

In step 1e-30, the aerial UE 1e-01 may report a measurement result through the MeasurementReport message 1e-30 when a specific event (e.g., event H1 or H2) has occurred, according to the configuration of the base station 1e-05 in step 1e-20 described above. If, in step 1e-20, the base station 1e-05 configures the aerial UE 1e-01 to include velocity information (e.g., velocity information including vertical velocity information) in the MeasurementReport message, the aerial UE 1e-01 may include the velocity information in the MeasurementReport message according to the configuration of the base station 1e-05. In addition, even when the base station 1e-05 does not provide a separate indication related to the velocity information in step 1e-20, the aerial UE 1e-01 may include the velocity information in the MeasurementReport message. For example, if the MeasurementReport message is triggered by the above-described event H1 or event H2, the aerial UE 1e-01 may include the velocity information (e.g., velocity information including vertical velocity information) in the MeasurementReport message according to an operation specified in the specification. Specifically, a method for the aerial UE 1e-01 to include velocity information in a MeasurementReport message may use at least one of the following options.

Option 1. A scheme of using a velocityEstimate-r16 field in CommonLocationInfo-r16 included in a MeasurementReport message.

When the base station 1e-05 configures a value of an includeCommonLocationInfo-r16 in an EventTriggerConfig IE to “True” in step 1e-20, the aerial UE 1e-01 may include a CommonLocationInfo-r16 IE in a MeasurementReport message when a corresponding event has occurred. In addition, when the base station 1e-05 configures a value of an include VerticalVelocity-rxx indicator in the EventTriggerConfig IE to “True” in the examples of Tables 11 and 12 described above in step 1e-20 described above, the aerial UE 1e-01 may include velocity information in a format (e.g., at least one of horizontal With Vertical Velocity or horizontalWith Vertical VelocityAndUncertainty) which includes vertical velocity in a velocityEstimate-r16 field in the CommonLocationInfo-r16 IE included in the MeasurementReport message. In addition, when the base station 1e-05 has configured a specific velocity format by using the include VerticalVelocity-rxx indicator in the EventTriggerConfig IE in the example of Table 13 or Table 14 described above in step 1e-20 described above, the aerial UE 1e-01 may include velocity information in a format configured by the base station 1e-05 in the velocityEstimate-r16 field in the CommonLocationInfo-r16 IE included in the MeasurementReport message.

Option 2. A method for defining a new field indicating velocity information in a MeasResult IE included in a MeasurementReport message.

In the case of Option 1, the aerial UE 1e-01 may also include velocity information (velocityEstimate) only when location information (e.g., CommonLocationInfo) is included in MeasurementReport. Therefore, if the Option 1 scheme is used, even when the aerial UE 1e-01 has only velocity information without location information or the base station 1e-05 does not require the location information of the aerial UE 1e-01 but requires only the velocity information, the aerial UE 1e-01 may have difficulty reporting only the velocity information without the location information. In order to remove the above-described limitation, a new field indicating velocity information may be defined in a MeasResult IE separately from the velocity information (e.g., velocityEstimate) included in the location information (e.g., CommonLocationInfo). Therefore, a new field (e.g., at least one of verticalVelocity-rxx or velocity-rxx) may be defined in the MeasResult IE as shown in Table 15 below.

TABLE 15

| | |
|---|---|
| MeasResults ::= | SEQUENCE { |

<<omitted>>

| | | |
|---|---|---|
| locationInfo-x16 | LocationInfo-r16 | OPTIONAL, |

<<omitted>>
[[

| | | |
|---|---|---|
| heightUE-rxx | INTEGER(−400..8880) | OPTIONAL, |
| verticalVelocity-rxx | VerticalVelocity-rxx | OPTIONAL, |

]]
}
VerticalVelocity-rxx ::= SEQUENCE {

| | |
|---|---|
| verticalDirection | ENUMERATED{upward, downward}, |
| verticalSpeed | INTEGER(0..255) |

}

When the aerial UE 1e-01 reports the event H1 or the event H2, important velocity information from the perspective of the base station 1e-05 may be vertical velocity. For example, as described above, the base station 1e-05 may control a transmission power of the aerial UE 1e-01 to alleviate an interference problem with a neighboring base station as the altitude of the aerial UE 1e-01 increases or decreases. In this case, the base station 1e-05 may optimize at least one of a start time point or a control period of the transmission power control, based on vertical velocity (e.g., an ascending or descending velocity) information of the aerial UE 1e-01. Therefore, as shown in Table 15, a field (e.g., VerticalVelocity) indicating vertical velocity of the aerial UE 1e-01 may be defined in the MeaResults IE. In addition, as described above, when a MeasurementReport message is triggered by the event H1 or the event H2, the aerial UE 1e-01 may include vertical velocity in the MeasurementReport message by using the above-described field (e.g., VerticalVelocity) according to an operation specified in the specification.

TABLE 16

| | |
|---|---|
| MeasResults ::= | SEQUENCE { |

<<omitted>>

| | | |
|---|---|---|
| locationInfo-r16 | LocationInfo-r16 | OPTIONAL, |

<<omitted>>
[[

| | | |
|---|---|---|
| heightUE-rxx | INTEGER(−400..8880) | OPTIONAL, |

| | | |
|---|---|---|
| velocity-rxx | Velocity-rxx | OPTIONAL, |

]]
}
Velocity ::= CHOICE {

| | |
|---|---|
| horizontalVelocity | HorizontalVelocity, |
| horizontalWithVerticalVelocity | HorizontalWithVerticalVelocity, |
| horizontalVelocityWithUncertainty | HorizontalVelocityWithUncertainty, |
| horizontalWithVerticalVelocityAndUncertainty | HorizontalWithVerticalVelocityAndUncertainty, |

...
}

The aerial UE 1e-01 may include the velocity information in the MeasurementReport message in a predetermined format by using a variable (e.g., velocity-rxx) defined as shown in Table 16. In this case, when the base station 1e-05 indicates the aerial UE 1e-01 to report the velocity information by using a specific format as shown in the example of Table 13 or Table 14 in step 1e-20 described above, the aerial UE 1e-01 may report the velocity information according to a format indicated by the base station 1e-05.

FIG. 1F is a block diagram illustrating an internal structure of a UE according to an embodiment of the disclosure.

Referring to FIG. 1F, the UE may include a radio frequency (RF) processor 1f-10, a baseband processor 1f-20, a storage unit 1f-30, and a controller 1f-40.

The RF processor 1f-10 may perform a function for transmitting and receiving a signal via a wireless channel, such as band conversion and amplification of the signal. That is, the RF processor 1f-10 may up-convert a baseband signal provided from the baseband processor 1f-20 to an RF band signal, may transmit the same through an antenna, and may down-convert an RF band signal received through the antenna to a baseband signal. For example, the RF processor 1f-10 may include a transmission filter, a reception filter, an amplifier, a mixer, an oscillator, a digital-to-analog converter (DAC), an analog-to-digital converter (ADC), and the like. Although only one antenna is illustrated in FIG. 1F, the UE may include multiple antennas. In addition, the RF processor 1f-10 may include multiple RF chains. Furthermore, the RF processor 1f-10 may perform beamforming. For the beamforming, the RF processor 1f-10 may adjust the phase and magnitude of signals transmitted/received through multiple antennas or antenna elements, respectively. In addition, the RF processor may perform MIMO, and may receive multiple layers when performing a MIMO operation.

The baseband processor 1f-20 may perform functions of conversion between baseband signals and bitstrings according to the physical layer specifications of the system. For example, during data transmission, the baseband processor 1f-20 may encode and modulate a transmitted bitstring to generate complex symbols. In addition, during data reception, the baseband processor 1f-20 may demodulate and decode a baseband signal provided from the RF processor 1f-10 to restore a received bitstring. For example, when following the orthogonal frequency division multiplexing (OFDM) scheme, during data transmission, the baseband processor 1f-20 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 1f-20 may split a baseband signal provided from the RF processor 1f-10 at the OFDM symbol level, may restore signals mapped to subcarriers through a fast Fourier transform (FFT) operation, and may restore a received bitstring through demodulation and decoding.

The baseband processor 1f-20 and the RF processor 1f-10 may transmit and receive signals as described above. Accordingly, each of the baseband processor 1f-20 and the RF processor 1f-10 may be referred to as a transmitter, a receiver, a transceiver, or a communicator. Furthermore, at least one of the baseband processor 1f-20 and the RF processor 1f-10 may include multiple communication modules to support multiple different radio access technologies. In addition, at least one of the baseband processor 1f-20 and the RF processor 1f-10 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mm Wave) (e.g., 60 GHz) bands.

The storage unit 1f-30 may store basic programs, application programs, and data, such as configuration information, for operation of the main base station. Particularly, the storage unit 1f-30 may store information regarding a second access node configured to perform wireless communication by using a second radio access technology. In addition, the storage unit 1f-30 may provide the stored data at the request of the controller 1f-40.

The controller 1f-40 may control the overall operation of the UE. For example, the controller 1f-40 may transmit and receive signals through the baseband processor 1f-20 and the RF processor 1f-10. In addition, the controller 1f-40 records data in the storage unit 1f-30 and reads the data from the storage unit 1f-30. To this end, the controller 1f-40 may include at least one processor. For example, the controller 1f-40 may include a communication processor (CP) configured to perform control for communication, and an application processor (AP) configured to control upper layers such as application programs. In addition, according to an embodiment of the disclosure, the controller 1f-40 may include a multi-connection processor 1f-42 configured to process processes operating in a multi-connection mode.

FIG. 1G is a block diagram illustrating a structure of a base station according to an embodiment of the disclosure.

Referring to FIG. 1G, the base station may include an RF processor 1g-10, a baseband processor 1g-20, a backhaul communication unit 1g-30, a storage unit 1g-40, and a controller 1g-50.

The RF processor 1g-10 may perform a function for transmitting and receiving a signal via a wireless channel, such as band conversion and amplification of the signal. That is, the RF processor 1g-10 may up-convert a baseband signal provided from the baseband processor 1g-20 to an RF band signal and then transmit the same through an antenna, and may down-convert an RF band signal received through the antenna to a baseband signal. For example, the RF processor 1g-10 may include a transmission filter, a reception filter, an amplifier, a mixer, an oscillator, a DAC, and an ADC. Although only one antenna is illustrated in the drawing, the first access node may include multiple antennas. In addition, the RF processor 1g-10 may include multiple RF chains. Furthermore, the RF processor 1g-10 may perform beamforming. For the beamforming, the RF processor 1g-10 may adjust the phase and magnitude of each of signals transmitted and/or received through multiple antennas or antenna elements. The RF processor may transmit one or more layers to perform a downward MIMO operation.

The baseband processor 1g-20 may perform functions of conversion between baseband signals and bitstrings according to the physical layer specifications of first radio access technology. For example, during data transmission, the baseband processor 1g-20 may generate complex symbols by encoding and modulating a transmission bit stream. In addition, upon receiving data, the baseband processor 1g-20 may restore the received bit stream through demodulation and decoding of the baseband signal provided from the RF processor 1g-10. For example, when following the OFDM scheme, during data transmission, the baseband processor 1g-20 may encode and modulate a transmitted bitstring to generate complex symbols, may map the complex symbols to subcarriers, and may configure OFDM symbols through an IFFT operation and CP insertion. In addition, during data reception, the baseband processor 1g-20 may split a baseband signal provided from the RF processor 1g-10 at the OFDM symbol level, may restore signals mapped to subcarriers through FFT operation, and may restore a received bitstring through demodulation and decoding. The baseband processor 1g-20 and the RF processor 1g-10 may transmit and receive signals as described above. Therefore, the baseband processor 1g-20 and the RF processor 1g-10 may be referred to as a transmitter, a receiver, a transceiver, a communication unit, or a wireless communication unit.

The backhaul communication unit 1g-30 may provide an interface for performing communication with other nodes within a network. That is, the backhaul communication unit 1g-30 may convert, into a physical signal, a bitstring transmitted from the main base station to another node, for example, an auxiliary base station, a core network, etc., and may convert a physical signal received from another node, into a bitstring.

The storage unit 1g-40 may store basic programs, application programs, and data, such as configuration information, for operation of the main base station. Particularly, the storage unit 1g-40 may store information regarding a bearer allocated to a connected UE, a measurement result reported from the connected UE, and the like. In addition, the storage unit 1g-40 may store information serving as a reference to determine whether to provide multi-connection to a UE or to suspend the same. In addition, the storage unit 1g-40 may provide the stored data at the request of the controller 1g-50.

The controller 1g-50 may control the overall operation of the main base station. For example, the controller 1g-50 may transmit/receive signals through the baseband processor 1g-20 and the RF processor 1g-10 or through the backhaul communication unit 1g-30. In addition, the controller 1g-50 may record data in the storage unit 1g-40 and reads the data from the storage unit 1g-40. To this end, the controller 1g-50 may include at least one processor. In addition, according to an embodiment of the disclosure, the controller 1g-50 may include a multi-connection processor 1g-52 configured to process processes operating in a multi-connection mode.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the embodiments of the disclosure, an element included in the disclosure is expressed in the singular or the plural according to presented embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the drawings in which methods of the disclosure are described, the order of the description does not always correspond to the order in which steps are performed, and the order relationship between the steps may be changed or the steps may be performed in parallel. In addition, in the drawings in which the embodiments of the disclosure are described, some of the elements may be omitted and only the other elements may be included without departing from the essential spirit and scope of the disclosure.

In the embodiments of the disclosure, some or all of the contents of each embodiment may be implemented in combination without departing from the essential spirit and scope of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented.

1. A method performed by a terminal in a wireless communication system, the method comprising:
transmitting, to a base station, terminal capability information comprising information on whether path reporting of the terminal is supported;
receiving, from the base station, configuration information regarding the path reporting, based on the terminal capability information; and
transmitting path information of the terminal to the base station, based on the configuration information,
wherein the path information comprises velocity information at at least one location on a path of the terminal, and
wherein a threshold time related to a signal strength of a target cell for a handover of the terminal is based on the velocity information.

2. The method of claim 1, wherein the information on whether the path reporting is supported comprises at least one of information on whether reporting of the velocity information is supported or information on a velocity format reportable by the terminal.

3. The method of claim 1,
wherein the configuration information comprises at least one of the number of times the path reporting is performed or a request for the velocity information, and
wherein the velocity information comprises at least one of information on horizontal velocity, information on vertical velocity, or information on velocity uncertainty.

4. The method of claim 1,
wherein the terminal is an unmanned aerial vehicle terminal, and
wherein the path information is flight path information of the unmanned aerial vehicle terminal.

5. A method performed by a base station in a wireless communication system, the method comprising:
receiving, from a terminal, terminal capability information comprising information on whether path reporting of the terminal is supported;
transmitting, to the terminal, configuration information regarding the path reporting, based on the terminal capability information; and
receiving path information of the terminal from the terminal, based on the configuration information,
wherein the path information comprises velocity information at at least one location on a path of the terminal, and
wherein a threshold time related to a signal strength of a target cell for a handover of the terminal is based on the velocity information.

6. The method of claim 5, wherein the information on whether the path reporting is supported comprises at least one of information on whether reporting of the velocity information is supported or information on a velocity format reportable by the terminal.

7. The method of claim 5,
wherein the configuration information comprises at least one of the number of times the path reporting is performed or a request for the velocity information, and
wherein the velocity information comprises at least one of information on horizontal velocity, information on vertical velocity, or information on velocity uncertainty.

8. The method of claim 5,
wherein the terminal is an unmanned aerial vehicle terminal, and
wherein the path information is flight path information of the unmanned aerial vehicle terminal.

9. A terminal in a wireless communication system, the terminal comprising:
a transceiver; and
at least one controller connected to the transceiver,
wherein the at least one controller is configured to:
transmit, to a base station, terminal capability information comprising information on whether path reporting of the terminal is supported,
receive, from the base station, configuration information regarding the path reporting, based on the terminal capability information, and
transmit path information of the terminal to the base station, based on the configuration information,
wherein the path information comprises velocity information at at least one location on a path of the terminal, and
wherein a threshold time related to a signal strength of a target cell for a handover of the terminal is based on the velocity information.

10. The terminal of claim 9, wherein the information on whether the path reporting is supported comprises at least one of information on whether reporting of the velocity information is supported or information on a velocity format reportable by the terminal.

11. The terminal of claim 9,
wherein the configuration information comprises at least one of the number of times the path reporting is performed or a request for the velocity information, and
wherein the velocity information comprises at least one of information on horizontal velocity, information on vertical velocity, or information on velocity uncertainty.

12. The terminal of claim 9,
wherein the terminal is an unmanned aerial vehicle terminal, and
wherein the path information is flight path information of the unmanned aerial vehicle terminal.

13. A base station in a wireless communication system, the base station comprising:
a transceiver; and
at least one controller connected to the transceiver,
wherein the at least one controller is configured to:
receive, from a terminal, terminal capability information comprising information on whether path reporting of the terminal is supported,
transmit, to the terminal, configuration information regarding the path reporting, based on the terminal capability information, and
receive path information of the terminal from the terminal, based on the configuration information,
wherein the path information comprises velocity information at at least one location on a path of the terminal, and
wherein a threshold time related to a signal strength of a target cell for a handover of the terminal is based on the velocity information.

14. The base station of claim 5, wherein the information on whether the path reporting is supported comprises at least one of information on whether reporting of the velocity information is supported or information on a velocity format reportable by the terminal.

15. The base station of claim 5,
wherein the configuration information comprises at least one of the number of times the path reporting is performed or a request for the velocity information, and
wherein the velocity information comprises at least one of information on horizontal velocity, information on vertical velocity, or information on velocity uncertainty.
